(19) United States
(12) Patent Application Publication
(10) Pub. No.: US 2013/0163124 A1
(43) Pub. Date: Jun. 27, 2013

(54) MAGNETIC READ SENSOR HAVING FLAT SHIELD PROFILE

(71) Applicants: Hicham M. Sougrati, Elk Grove, CA (US); Quang Le, San Jose, CA (US); Honglin Zhu, Fremont, CA (US)

(72) Inventors: Hicham M. Sougrati, Elk Grove, CA (US); Quang Le, San Jose, CA (US); Honglin Zhu, Fremont, CA (US)

(73) Assignee: Hitachi Global Storage Technologies Netherlands B.V., Amsterdam (NL)

(21) Appl. No.: 13/335,657

(22) Filed: Dec. 22, 2011

(51) Int. Cl. G11B 5/127

(52) U.S. Cl. 360/319; G9B/5.04

(57) ABSTRACT

A magnetic read sensor having a flat shield for improved gap thickness definition and control. The magnetic read head includes a sensor stack and hard bias layer formed at either side of the sensor stack. A SiNx hard bias capping layer is formed over the hard bias layers between the hard bias structure and the upper magnetic shield. The hard bias capping layer has an upper surface that has been planarized by chemical mechanical polishing that is co-planar with an upper surface of the sensor stack. The read sensor is constructed by a method wherein the hard bias capping layer is constructed of a material (e.g. SiNx) that is also used as a CMP stop layer and that can be planarized by chemical mechanical polishing while having some resistance to removal by chemical mechanical polishing.

### FIELD OF THE INVENTION

The present invention relates to magnetic data recording and more particularly to a magnetic read head having a flat, well defined top shield profile for improved gap thickness definition, which is made possible by the use of a SiNx hard bias capping layer that also serves as a CMP stop layer.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating, but when the disk rotates, air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes at least one coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data. The write field, then, travels through a magnetically soft under-layer of the magnetic medium to return to the return pole of the write head.

A magnetoresistive sensor such as a Giant Magnetoresistive (GMR) sensor, or a Tunnel Junction Magnetoresistive (TMR) sensor can be employed to read a magnetic signal from the magnetic media. The sensor includes a nonmagnetic conductive layer (if the sensor is a GMR sensor) or a thin nonmagnetic, electrically insulating barrier layer (if the sensor is a TMR sensor) sandwiched between first and second ferromagnetic layers, hereinafter referred to as a pinned layer and a free layer. Magnetic shields are positioned above and below the sensor stack and can also serve as first and second electrical leads so that the electrical current travels perpendicularly to the plane of the free layer, spacer layer and pinned layer (current perpendicular to the plane (CPP) mode of operation). The magnetization direction of the pinned layer is pinned perpendicular to the air bearing surface (ABS) and the magnetization direction of the free layer is located parallel to the ABS, but free to rotate in response to external magnetic fields. The magnetization of the pinned layer is typically pinned by exchange coupling with an antiferromagnetic layer.

When the magnetizations of the pinned and free layers are parallel with respect to one another, scattering of the conduction electrons is minimized and when the magnetizations of the pinned and free layer are antiparallel, scattering is maximized. a read mode the resistance of the spin valve sensor changes about linearly with the magnitudes of the magnetic fields from the rotating disk. When a sense current is conducted through the spin valve sensor, resistance changes cause potential changes that are detected and processed as playback signals.

The magnetic sensor is located between top and bottom shields, and the distance between these shields defines the gap length. In order to increase the data density by increasing the number of bits per inch of data track, it is necessary to reduce the gap thickness as much as possible. Therefore, in a high data density recording system it is necessary manufacture the shields as flat as possible in order to provide a well defined gap thickness. However, current manufacturing processes used to define the sensor result in magnetic top shields that are not sufficiently flat to provide a well defined gap length. Therefore there remains a need for a sensor design that can be manufactured to have a flat shield for well defined gap thickness.

### SUMMARY OF THE INVENTION

The present invention provides a magnetic read head that includes a sensor stack having first and second laterally opposed sides. A magnetic hard bias structure is formed adjacent to each of the first and second sides of the sensor stack, and a hard bias capping layer comprising SiNx formed over each of the first and second hard bias layers. A magnetic shield formed over the sensor stack and over the hard bias capping layers.

The magnetic sensor can be constructed by a method that includes, depositing a sensor layer and then depositing a first CMP stop layer over the sensor stack. A mask structure is formed over the first CMP stop layer and a first ion milling is performed to transfer the image of the mask structure onto the under-lying first CMP stop layer and sensor material. A hard magnetic bias material is deposited followed by a second CMP stop layer. A chemical mechanical polishing process is then performed to remove the mask structure; and a second ion milling is performed to remove the first CMP stop layer, leaving a portion of the second CMP stop layer remaining over the hard magnetic bias material.

The second CMP stop layer can be formed of SiNx, and the first CMP stop layer can optionally also be formed of SiNx. This process forms a very flat upper shield, which provides a well defined gap thickness for improved read sensor performance. One advantage of the use of SiNx in the second CMP stop layer is that it does not have to be completely removed, since it can double as a hard bias capping layer. It also can advantageously be planarized by chemical mechanical polishing (as opposed to diamond like carbon, which cannot) and does not form any fences or notches, which would result in a poorly defined upper shield.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is an enlarged ABS view of a magnetoresistive according to an embodiment of the invention;

FIGS. 4-11. show a view along a plane parallel with an air bearing surface plane of a magnetic sensor in various intermediate stages of manufacture in order to describe a method of manufacturing a magnetic read head according to an embodiment of the invention.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

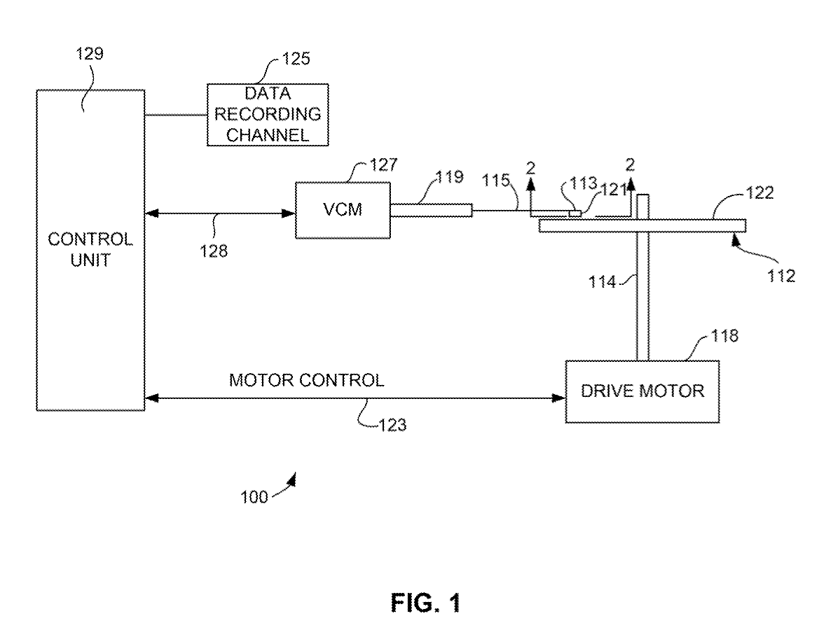

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

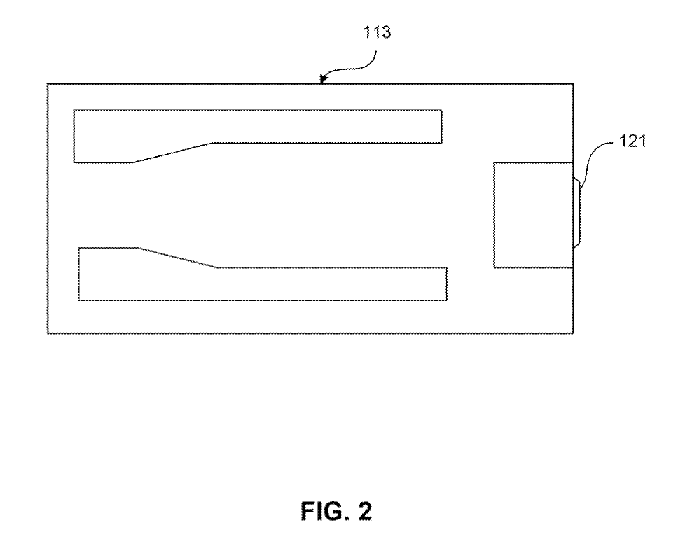

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

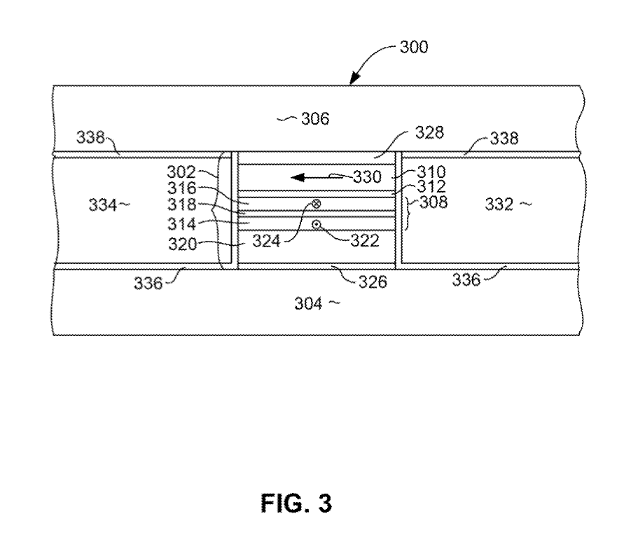

FIG. 3 shows a magnetic read head 300 having a sensor stack 302 that is sandwiched between first and second magnetic shields 304, 306. The magnetic shields 304, 306 can be constructed of an electrically conductive, magnetic material such as NiFe so that they can function as electrical leads for supplying a sense current to the sensor stack 302 as well as functioning as magnetic shields. The sensor stack can include a magnetic pinned layer structure 308, a magnetic free layer 310 and a non-magnetic barrier or spacer layer 312 sandwiched there-between. The sensor stack 302 can also include a seed layer 326 at its bottom, which can be provided to ensure a desired grain structure formation in the above deposited layers. The sensor stack 302 can also include a capping layer 328 at its top to protect the under-lying layers from damage during manufacture. The capping layer 328 can be, for example, Ru or Ru/Ta/Ru.

The pinned layer structure can include first and second magnetic layers 314, 316 that are anti-parallel coupled across a non-magnetic antiparallel coupling layer 318 such as Ru sandwiched there-between. The first magnetic layer 314 can be exchange coupled with a layer of antiferromagnetic material (AFM. layer) 320, which can be constructed of a material such as IrMn or PtMn. This exchange coupling strongly pins the magnetization of first magnetic layer 310 in a first direction perpendicular to the ABS as indicated by arrowhead symbol 322. Anti-parallel coupling between the magnetic layers 314, 316 pins the magnetization of the second magnetic layer 316 in a second direction that is anti-parallel with the first direction and perpendicular to the ABS as indicated by arrow-tail symbol 324.

The free layer 310 has a magnetization that is biased in a direction that is generally parallel with the ABS as indicated by arrow 330. Although the magnetization 330 is biased in this direction, it is free to move in response to an external magnetic field, such as from a magnetic medium. The biasing of the magnetization 330 is achieved by a magnetic bias field from hard magnetic bias layers 332, 334. These magnetic bias layers 332, 334 are permanent magnets formed of a high coercivity magnetic material such as CoPt, or CoPtCr. The bias layers 332, 334 are separated from the sensor stack 302 and from at least the bottom shield 304 by thin, non-magnetic, electrically insulating layers such as alumina 336, 338. In addition, hard bias capping layers 338 are provided at the top of the hard bias layers 332, 334, separating the hard bias layers 332,334 from the upper shield 306. The capping layers 338 are constructed of a novel material, preferably SiNx that can function as both a hard bias capping layer as well as functioning as a chemical mechanical polish stop layer (CMP stop layer), as will be seen herein below. The use of this novel hard bias capping material 338 as used in a manufacturing process that will be described herein below, allow the upper magnetic shield 306 to have a very flat profile for excellent gap thickness definition. The hard bias capping layers 338 have smooth planar upper surfaces that are co-planar with the upper surface of the sensor stack 302. Therefore, therefore, the interface between the upper shield 306 and the sensor stack 302 and hard bias capping layer 338 is smooth and flat to provide a well defined gap thickness.

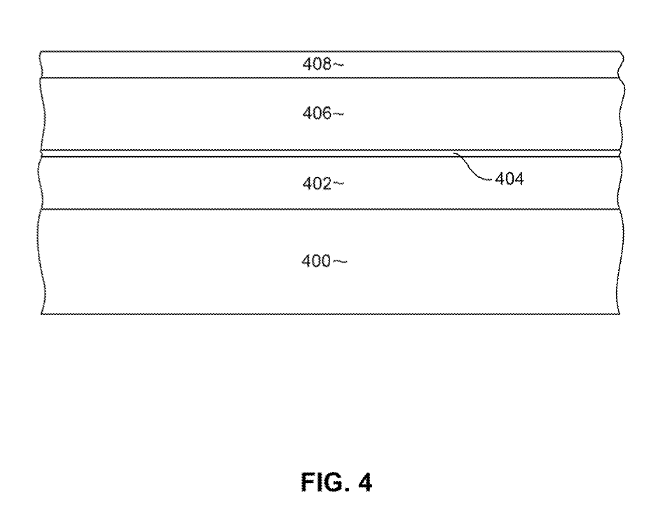

FIGS. 4-11 show a magnetic read head in various intermediate stages of manufacture in order to describe a method for manufacturing a magnetic read head according to an embodiment of the invention. With particular reference to FIG. 4, a substrate 400 is provided. The substrate may be a layer of alumina that has been planarized by chemical mechanical polishing. A series of sensor layers 402 are then deposited over the substrate. The sensor layers can be the various layers of the sensor stack 302 described above with reference to FIG. 3 or could be other layers of a sensor having some other structure and can be deposited by a process such as sputter deposition or ion beam deposition. Although consisting of many different layers, the sensor layers are represented collectively as sensor layer 402 for purposes of clarity in FIG. 4.

With continued reference to FIG. 4, a first layer of material that is resistant to removal by chemical mechanical polishing (first CMP stop layer) is deposited over the sensor layer 402. The first CMP layer can be a material such as diamond like carbon or amorphous carbon, but is preferably SiNx for reasons that will become apparent below. A plurality of mask layers are then deposited over the CMP stop layer. These layers can include a release layer 406 constructed of a soluble polyimide material such as DURIMIDE® which can also function as an image transfer layer and as a bottom anti-reflective coating layer (BARC), and a photoresist layer 408 formed over the release layer 406. Other layers could (not shown) could also be included as well, such as an additional hard mask layer additional antireflective coating layer, etc.

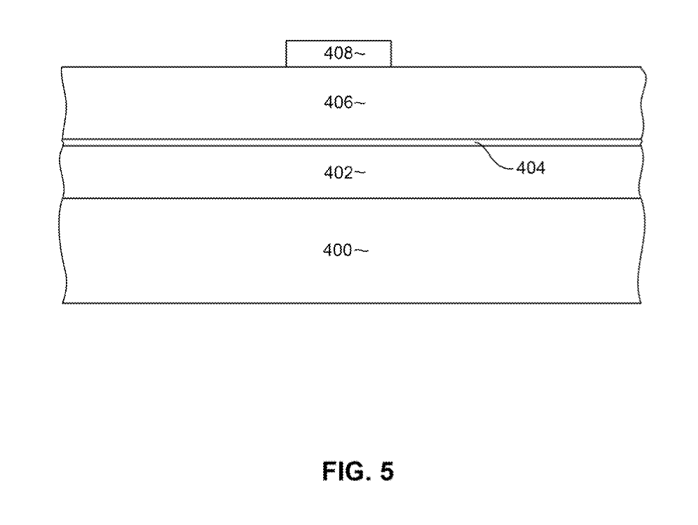

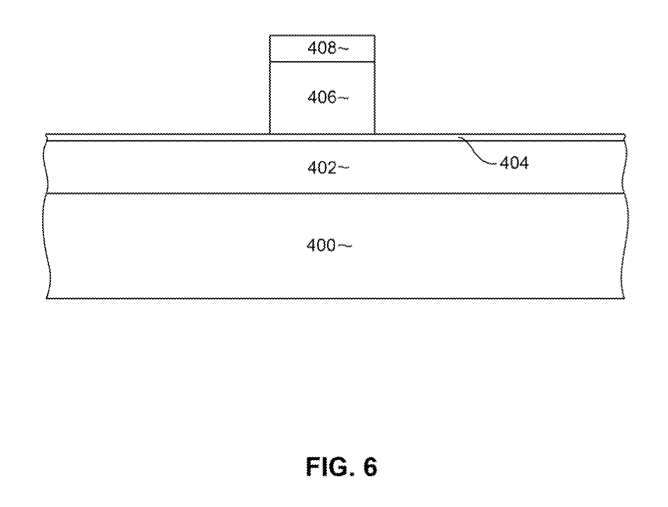

With reference to FIG. 5, the photoresist layer 408 is photolithographically patterned to form a mask structure that is configured to define a track width of the sensor. Then, a reactive ion etching (RIE) can be performed to transfer the image of the photoresist layer 408 onto the underlying release layer 406. The RIE can be stopped at the layer 404, which can function as a RIE stop layer as well as a CMP stop layer. This leaves a structure as shown in FIG. 6.

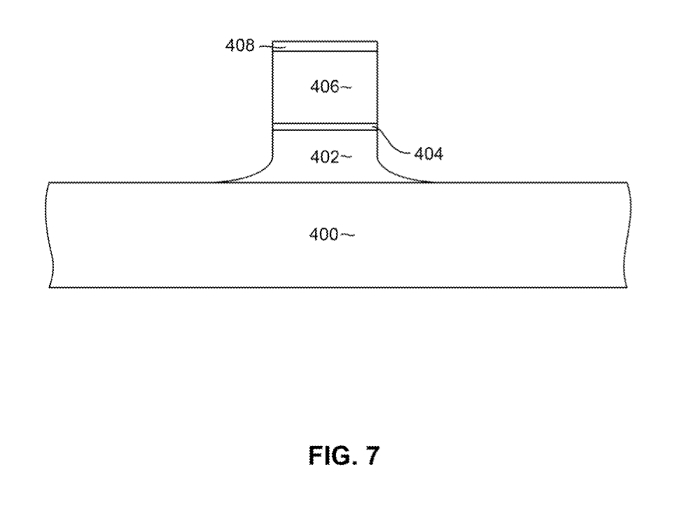

An ion milling can then be performed to remove portions of the CMP stop layer 404 and sensor material 402 that is not protected by the mask layers 406, 408, leaving a structure as shown in FIG. 7. All or a portion of the photoresist 406 will likely be consumed by this ion milling process. The ion milling can be a sweeping ion milling and can be performed at one or more angles relative to normal in order to form a desired side wall profile and to avoid the formation of re-deposited material (re-dep) on the sides of the sensor.

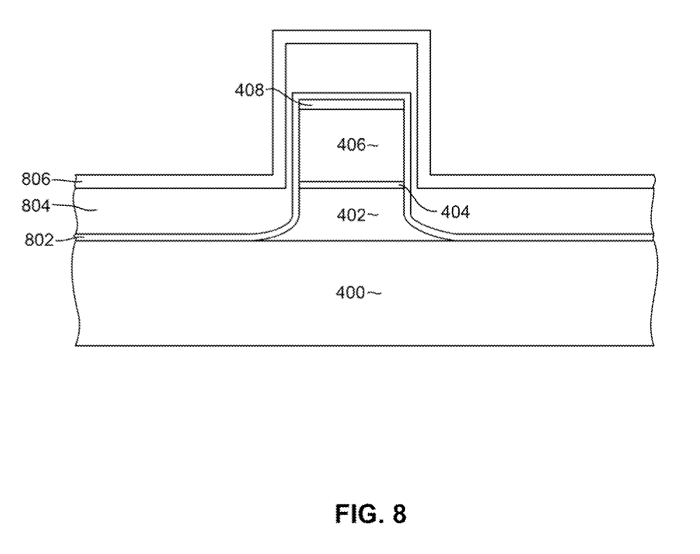

With reference to FIG. 8, a thin, non-magnetic, electrically insulating material 802 is deposited. This layer 802 can be alumina Al₂O₃ or SiNx and is preferably deposited by a conformal deposition process such as atomic layer deposition (ALD) or some other suitable method. Then, a hard magnetic bias layer 804 is deposited. The hard bias layer 804 is a material having a high magnetic coercivity, such as CoPt or CoPtCr. It may also include one or more seed layers or under-layers (not shown). The hard bias layer is preferably deposited by a deposition method such as atomic layer deposition (ALD). A second layer of material that is resistant to removal by chemical mechanical polishing (second CMP stop layer) 806 is deposited over the hard bias layer 804.

This second CMP stop layer 806 is formed of a material such that can function as a CMP stop layer and also can function as a hard bias capping layer that can be left in the finished read head. While this second CMP stop layer 806 is resistant to removal by CMP it is not entirely impervious to removal by CMP (as a material such as diamond like carbon would be). This allows for some planarization by chemical mechanical polishing as will be further discussed below. To this end, the second CMP stop layer is preferably SiNx.

The hard bias layer 804 is preferably deposited to a thickness that is just slightly below the top of the sensor layer 402 (e.g. slightly below the bottom of the first CMP stop layer 404). This will leave room for the second CMP stop layer 806 in the finished head after the first CMP stop layer 404 has been removed, and allowing the top of the remaining second CMP stop layer 806 to be parallel with the top of the sensor stack 404 as will be seen below, allowing for the formation of a very flat upper shield. In addition, the second CMP stop layer 806 is deposited to be thicker than the first CMP stop layer 404 for reasons that will be apparent below. The thickness of the first CMP stop layer 404 can be 20 A to 150 A while the thickness of the second CMP stop layer 806 can be 40 A to 200 A.

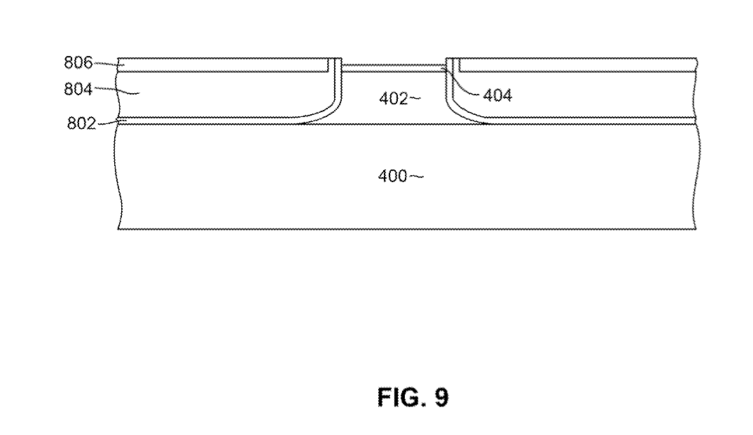

After the layers 802, 804, 806 have been deposited, a chemical mechanical polishing process is performed. This removes the mask layers 406, 408, and also planarizes the layer 806, leaving a structure as shown in FIG. 9. As discussed above, the second CMP stop layer 806 is a material (e.g. SiNx) that while being resistant to CMP is also slightly removed by CMP. This allows the CMP process to form a smooth planar upper surface on the layer 806. To this end, the layer 806 should be deposited sufficiently thick to ensure that a desired amount of this material 806 remains after CMP to protect the hard bias layer 804 both during and after CMP. In addition, the amount of second CMP stop layer remaining after CMP should be thicker than the amount of first CMP stop layer remaining after CMP, for reasons that will be clearer below.

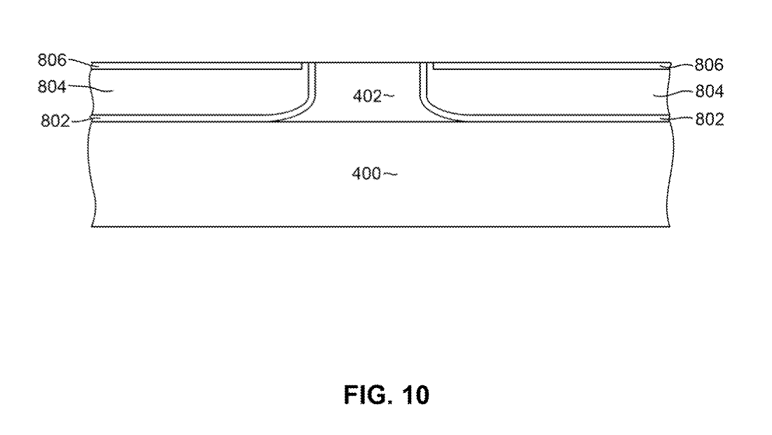

After the CMP process has been performed, an ion milling process is performed to remove all of the remaining first CMP stop layer 404, leaving a structure as shown in FIG. 10. As mentioned above, the second CMP stop layer 806 was deposited thicker than the first CMP stop layer 404. Therefore, an ion milling that is performed for a sufficient strength and duration to remove all of the first CMP stop layer 404 (FIG. 9) will leave a desired amount of the second CMP stop layer 806 to act as a hard bias cap layer to protect the hard bias layers 804. As can be seen, this process results in an extremely flat, smooth, planar upper surface across the hard bias capping layers (second CMP stop layer 806) and sensor material 402.

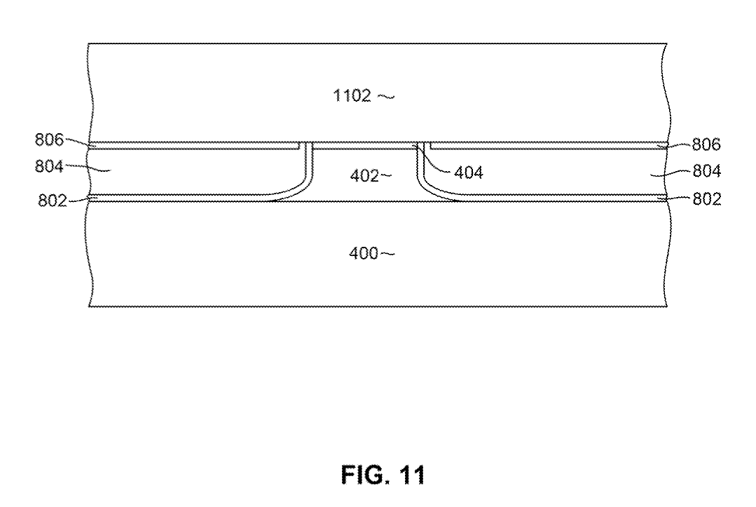

Finally, with reference to FIG. 11, a magnetic material is deposited, such as by an electroplating process to form an upper shield 1102. Because the previous CMP and ion milling steps left a very flat, smooth, planar upper surface across the layers 806, 402, the subsequently formed upper shield 1102 can be formed very flat with a flat bottom surface. This, therefore, allows the gap thickness (spacing between the upper shield 1102 and bottom shield 400) to be very well defined. As discussed above, this results in greatly improved sensor performance.

It should be pointed out that while the above described process defines the track-width of the sensor, an additional masking and ion milling process will be needed to define the back edge (stripe height) of the sensor. These additional masking and ion milling steps can be performed either before or after the above described process steps.

The above process results in a flat, well defined upper shield as discussed. Previously used processes, such as those that used diamond like carbon (DLC) as a second CMP stop layer, resulted in notching at the junction between hard bias region and the sensor region, and also resulted in fencing peaks, formed as a result of redeposited material during ion milling that is not sufficiently removed by chemical mechanical polishing. This uneven topography resulted in a poorly defined. non-flat upper shield. The present invention as described above overcomes this, problem, forming a flat, well defined upper shield.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetic read head, comprising:
a sensor stack having first and second laterally opposed sides;
a magnetic hard bias structure formed adjacent to each of the first and second sides of the sensor stack;
a hard bias capping layer comprising SiNx formed over each of the first and second hard bias layers; and
a magnetic shield formed over the sensor stack and over the hard bias capping layers.

2. The magnetic read head as in claim 1 wherein each of the hard bias capping layers has a smooth, flat surface that is coplanar with a surface of the sensor stack.

3. The magnetic read head as in claim 1 wherein the magnetic shield is flat.

4. The magnetic read head as in claim 1 having an interface between the magnetic shield and the sensor stack and hard bias capping layers, the interface being smooth and flat.

5. A magnetic data recording system, comprising:
a housing;
a magnetic media held within the housing;
an actuator;
a slider connected with the actuator for movement adjacent to a surface of the magnetic media; and
a magnetic read head formed on the slider, the magnetic read head further comprising:
a sensor stack having first and second laterally opposed sides;
a magnetic hard bias structure formed adjacent to each of the first and second sides of the sensor stack;
a hard bias capping layer comprising SiNx formed over each of the first and second hard bias layers; and
a magnetic shield formed over the sensor stack and over the hard bias capping layers.

6. The magnetic data recording system as in claim 5 wherein each of the hard bias capping layers has a smooth, flat surface that is coplanar with a surface of the sensor stack.

7. The magnetic data recording system as in claim 5 wherein the magnetic shield is flat.

8. The magnetic data recording system as in claim 5 having an interface between the magnetic shield and the sensor stack and hard bias capping layers, the interface being smooth and flat.

9. A method for manufacturing a magnetic read head, comprising:
depositing a sensor layer;
depositing a first CMP stop layer over the sensor stack;
forming a mask structure over the first CMP stop layer;
performing a first ion milling to transfer the image of the mask structure onto the under-lying first CMP stop layer and sensor material;
depositing a hard magnetic bias material;
depositing a second CMP stop layer;
performing a chemical mechanical polishing process to remove the mask structure; and
performing a second ion milling to remove the first CMP stop layer, leaving a portion of the second CMP stop layer remaining over the hard magnetic bias material.

10. The method as in claim 9, wherein the second CMP stop layer comprises SiNx.

11. The method as in claim 9 wherein the first and second CMP stop layers each comprise SiNx.

12. The method as in claim 9 wherein the chemical mechanical polishing forms a smooth flat surface on the second CMP stop layer.

13. The method as in claim 9 wherein the second CMP stop layer is deposited thicker than the first CMP stop layer so that the second ion milling can remove all of the first CMP stop layer while leaving a portion of the second CMP stop layer remaining over the hard magnetic bias layers.

14. The method as in claim 9 wherein the chemical mechanical polishing and second ion milling are performed in such a manner to leave the second CMP stop layer with an upper surface that is co-planar with an upper surface of the sensor stack.

15. The method as in claim 9 wherein the magnetic hard bias material is deposited to such a thickness that it has an upper surface that is below an upper surface of the sensor stack.

16. The method as in claim 9 further comprising after performing the first ion milling and before depositing the hard magnetic bias material, depositing a thin, non-magnetic, electrically insulating material.

17. The method as in claim 9 further comprising, after performing the second ion milling, forming an upper magnetic shield over the sensor stack and the second CMP stop material.

18. The method as in claim 9 wherein the hard magnetic bias material comprises CoPt or CoPtCr.

19. The method as in claim 9 wherein the sensor material further comprises a pinned magnetic layer, a free magnetic layer, a non-magnetic layer sandwiched between the pinned magnetic layer and the free magnetic layer and a non-magnetic capping layer formed over the free magnetic layer.
